(19) United States
(12) Patent Application Publication
(10) Pub. No.: US 2005/0276234 A1
(43) Pub. Date: Dec. 15, 2005

(54) Method and architecture for efficiently delivering conferencing data in a distributed multipoint communication system

(76) Inventors: Yemeng Feng, Union City, CA (US); Songxiang Wei, San Jose, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/865,599

(22) Filed: Jun. 9, 2004

(51) Int. Cl. H04L 12/56

(52) U.S. Cl. 370/260

(57) ABSTRACT

A novel solution is provided for preventing the top server of a multipoint communication system from being overburdened when a large number of clients are joining a conference from different locations. A distributed real time communication database architecture is defined within the multipoint communication system network topology. The distributed real time database has a plurality of nodes logically connected in a hierarchical tree structure which is dynamically formed per the multipoint domain of the communication system. The database architecture provides a distributed repository allowing resource objects to be managed in a structure close to the actual application resource data model, that enables the participating clients to obtain resource data from its closest local server, instead of from the top server.

### BACKGROUND OF THE INVENTION

The International Telecommunication Union (ITU) Telecommunications. Standardization Sector's recommendation for data protocols for multimedia conferencing (ITU T.120) defines a standard for multipoint communication services, which is the basic architecture used by most of current popular media conferencing products such as Microsoft Net-Meeting, IBM Same-Time, WebEx Web-Meeting and most traditional teleconferencing products.

In general, a multipoint communication service provides a multipoint connection-oriented data service. It collects point-to-point transport connections and combines them to form a multipoint domain. Within that domain a large number of logical channels are provided that can provide one-to-one, one-to-many and many-to-one data delivery.

FIG. 1 illustrates a typical prior art T.120 multipoint communication network topology having a typical one-to-many data delivery path within the distributed client-server architecture. In this exemplary network, all clients are within one multipoint domain and all clients except Client-5 have joined one logic channel-n. If one client, here Client-2, sends data to channel-n, a copy of the data will be delivered to all clients in channel-n as indicated by the arrows.

With the increasing popularity of internet multimedia conferencing, a high performance and scalable system to accommodate large number of participants from different location within a limited network bandwidth is required. To achieve such a goal, the conference data delivery needs to be distributed. In general, conference data falls into three categories: (1) real time media data; (2) resource data, which assists in establishing communications among client applications and helps peer clients to discover a common resource on which to communicate; and (3) necessary history media data and status information, required by the newly joined client for synchronization purposes.

A distributed real time multipoint communication server architecture has now been used by some commercial products or services to distribute the category (1) data. In this architecture, a central registry repository at the top server is still used to store all the category (2) and category (3) data. When there are large numbers of participants, since all the category (2) and (3) data will be delivered to all participants via the central repository at the top server, it will overburden the top server and eventually affect the overall service quality of the system.

Thus, there exists a need to address the above problem that when there are a large numbers of participants joining a conference from different locations, the top server will not be overburdened.

### SUMMARY OF THE INVENTION

The present invention solves this need. The present invention is directed to an architecture and method for effectively distributing the delivery of category (2) and category (3) data in a multipoint communication system in such a way that each participant in the multipoint communication system can get the data from its closest local server. Thus the top server is not the only server responsible for delivering this data and therefore the system can operate more efficiently.

The database architecture according to principles of the present invention is a distributed real time multipoint communication registry-database (COMM-DB) defined within a distributed multipoint communication system. This distributed database is used by multipoint communication system clients, or client applications, to share (store and retrieve) configuration data, resource objects and history media content and status information, which can assist in establishing communications among the client applications, help peer clients to discover a common resource on which to communicate, and also can cache the media contents for future use.

Additionally, a method for efficiently distributing conferencing data in a distributed multipoint communication system is provided. The method includes steps of providing a distributed real time communication database defined within the multipoint communication network topology and using the real time distributed communication database to share conferencing data between participating clients, such that a client can obtain required conferencing data from its closest server.

### BRIEF DESCRIPTION OF THE DRAWINGS

Other features and advantages of the invention, both as to its structure and its operation, will best be understood and appreciated by those of ordinary skill in the art upon consideration of the following detailed description and accompanying drawings, in which:

FIG. 1 illustrates a simplified representation of a typical prior art ITU T.120 multipoint communication network topology;

FIG. 2 illustrates a distributed real time multipoint communication registry-database architecture implemented in a multipoint communication system according to principles of the present invention;

FIG. 3 illustrates the hierarchical tree structure of data stored in the COMM-DB according to principles of the present invention;

FIGS. 4-7 illustrate the exchange of messages within the multipoint communication system during the execution of Key commands;

FIGS. 8-10 illustrate the exchange of messages within the multipoint communication system during the execution of common Object operations; and

FIGS. 11-21 illustrate sequence of events for exemplary object type operations in accordance with principles of the present invention.

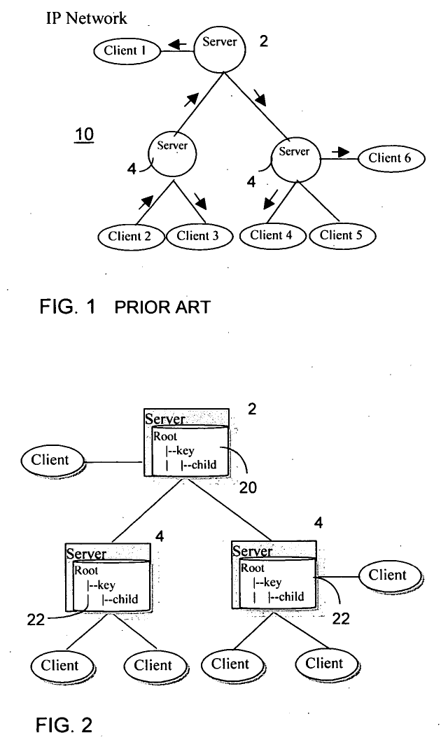

### DETAILED DESCRIPTION OF THE INVENTION

Referring to FIG. 2, the hierarchical structure of the COMM-DB architecture according to principles of the present invention is illustrated here. The COMM-DB nodes are logically connected in a hierarchical tree. The forming of this hierarchical tree is along with the forming of the hierarchical tree of the distributed multipoint communication servers 2, 4. This tree is dynamically formed per multipoint domain. The COMM-DB node residing at the top of the multipoint communication system will automatically become the top COMM-DB node 20.

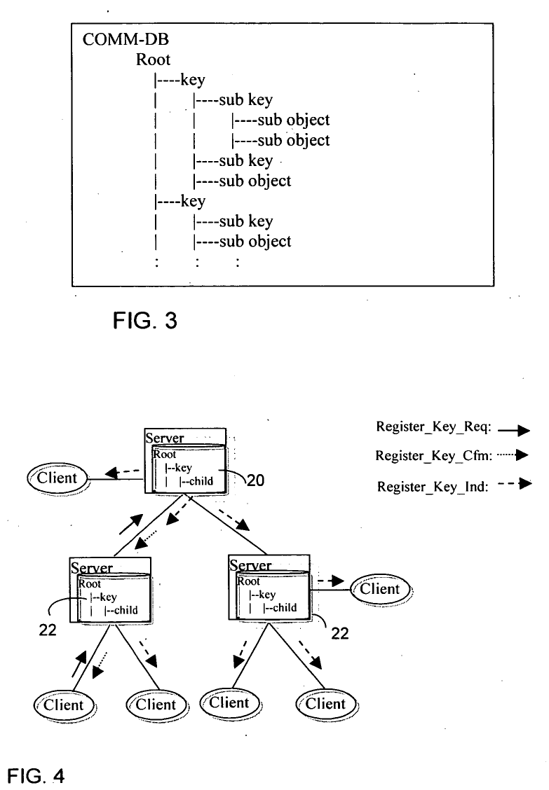

The internal data structure of a COMM-DB can be seen in FIG. 3. The COMM-DB manages the internal data in a hierarchically structured tree. Each node in the tree is called a Key. Each leaf in the tree is called an Object. Each key can contain both sub-keys and sub-objects. An active COMM-DB stores the Keys and Objects primarily in memory, with some type of object's data stored in binary files.

A description of the COMM-DB Key and commands performed on Keys will now be discussed. In accordance with principles of the present invention, a Key defines properties of clients participating in the distributed multipoint communication system. It should be understood by those skilled in the art that a client as referred to herein means a client or client application. A Key consists of the following elements: Key name, Key ID and Key attributes. The Key elements are described as follows.

Key Name

Each COMM-DB key has a name assigned by the client consisting of one or more printable ANSI characters—that is, characters ranging from values 32 through 127. Key names cannot include a space, a backslash (\), or a wildcard character (* or ?). The name of each sub-key is unique with respect to the key that is immediately above it in the hierarchy. Key names are not localized into other languages, although object's name may be.

Key name length is limited to 256 characters.

Key ID

Once a key is registered, a unique 4 byte long unsigned ID will be assigned to this key by the server. The lower two bytes of the ID serve as an index for distributed multipoint communication system to quickly locate this key object in later COMM-DB operations, the higher two bytes contain a random number for validation.

In each COMM-DB, there exists a key array. Each element of the array refers to actual key object. To locate a key object by key_id, it only takes one basic instruction:
Key=Key_array[key_id&0xffff];
   Key Attributes

Modification Permission

This attribute defines who has the permission to modify/delete the key. Three types of permissions are defined:
INHERIT: Inherit its parent key's modification permission
OWNER-ONLY: Only owner has the modification permission
PUBLIC: Everyone has the modification permission

Monitor Channel

This attribute defines the monitor channel for the key and its sub objects. Any change to this key and its sub objects will be notified to all the nodes which have joined this monitor channel.

When a new client joins this channel, it will automatically be notified with all the contents (key info, sub key and sub contents) of this key.

Ownership

It specifies who own this key. When Modification Permission is set as Owner-Only, ownership is required to modify/delete this key and sub objects.

The commands which can be executed for COMM-DB keys are described below and illustrated in FIGS. 4-7.

Referring to FIG. 4, the message exchange for a Register command is shown. A new key can be registered by a client application issuing a Register_Key_Req command to the top COMM-DB 20 as indicated by the solid arrow. After receiving this request, the top COMM-DB 20 needs to check if this key already exists or if the requestor has the permission by checking its parent key's modification permission attribute. If this is not a duplicated key and it is allowed, top COMM-DB will create the new key, assign an key id for it, insert it into the local tree repository, then confirm the requestor with a SUCCESS Register_Key_Cfm message indicated by the dotted line arrow. Otherwise, top COMM-DB will confirm the requestor with a FAILURE Register_Key_Cfm message. Upon the successful registration, top COMM-DB 20 will issue a Register_Key_Ind message, as indicated by the dashed line arrow, to notify all the nodes joined in its monitor channel that this new key is registered. After receiving the Register_Key_Ind message, client applications may handle it according to its own application logic, Sub COMM-DBs will insert this new key into its local tree repository.

This table shows the parameters used in register-key events:

| Parameter | Request | Confirm | Indication | Comments |
|---|---|---|---|---|
| Key name | x | x | x | Full name, contains full |
| | | | | path. Started from root |
| | | | | ‘\’. |
| | | | | E.g, |
| | | | | “\Startup\Sess_Table” |
| Key ID | — | x | x | |
| Attr-Owner- | x | x | x | |
| Node-ID | | | | |
| Attr- | x | x | x | |
| Modification- | | | | |
| Permission | | | | |
| Attr-Monitor- | x | x | x | |
| Channel-ID | | | | |
| Result | — | x | — | |

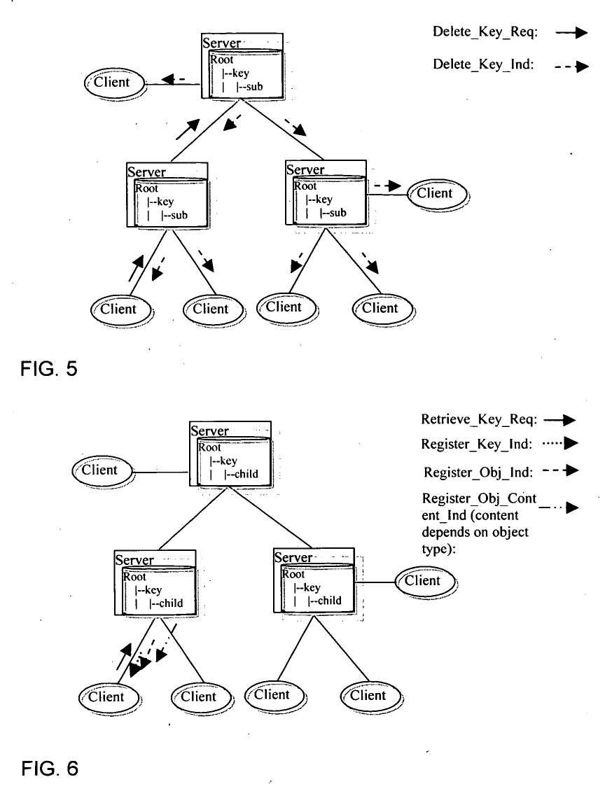

Referring now to FIG. 5, a Delete Key command is shown. A key can be deleted by a client application issuing a Delete_Key_Req command, as indicated by the solid line arrow, to the top COMM-DB. After receiving this request, top COMM-DB needs to check if the requestor has the required permission by checking its modification permission attribute. If it is allowed, top COMM-DB will delete this key and all its sub keys and sub objects from the local tree repository. Upon the successful delete, Top COMM-DB will issue a Delete_Key_Ind message, as indicated by the dash lined arrow, to notify all the nodes joined to its monitor channel that this key has been deleted. After receiving the Delete_Key_Ind message, client applications may handle it according to its own application logic. The sub COMM-DBs will delete this key and all the sub keys and sub objects under this key from its local tree repository.

This table shows the parameters used in delete-key events:

| Parameter | Request | Indication | Comments |
|---|---|---|---|
| Key name | x | x | Full name, contains full |
| | | | path. Started from root |
| | | | ‘\’. |
| | | | E.g, |
| | | | “\Startup\Sess_Table” |
| Key ID | x | x | |
| Requestor- | x | x | |
| Node-ID | | | |

A further Key command is shown in FIG. 6. Here, a client application may issue a Retrive_Key_Req command, indicated by the solid line arrow, to its parent COMM-DB to retrieve the key attribute information and all its contents (sub key and sub objects). After receiving this request, parent COMM-DB needs to return all the key information and its contents (sub key and sub objects) to the requester, if more than one sub key or sub object exist, it will package them in appropriate batches to optimize network transportation.

This table shows the parameters used in retrieve-key events:

| Parameter | Request | Comments |
|---|---|---|
| Key name | X | Full name, contains full |
| | | path. Started from root ‘\’. |
| | | E.g, “\Startup\Sess_Table” |
| Key ID | ◯ | |

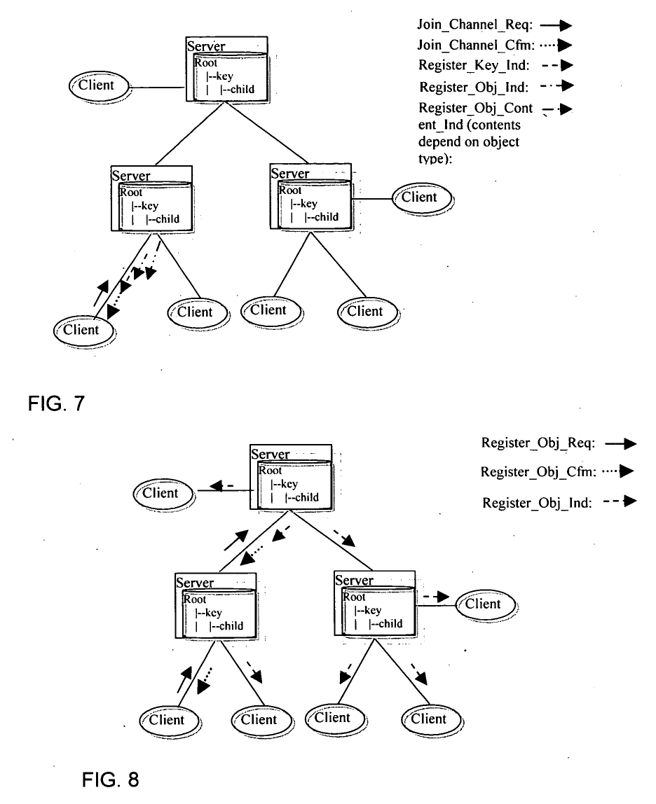

A still further Key command is illustrated in FIG. 7. Here a Notify key contents command for a newly joined client application is shown. When a new client application joins a monitor channel of a key, it will issue a Join_Channel_Req message, indicated by the solid line arrow, to its local COMM-DM. This message triggers the local COMM-DB to send the monitored key attribute information and all its sub contents (sub key and sub objects) to this new joiner. If more than one sub key or sub object exist for each monitored key, it will package them in appropriate batches to optimize network transportation.

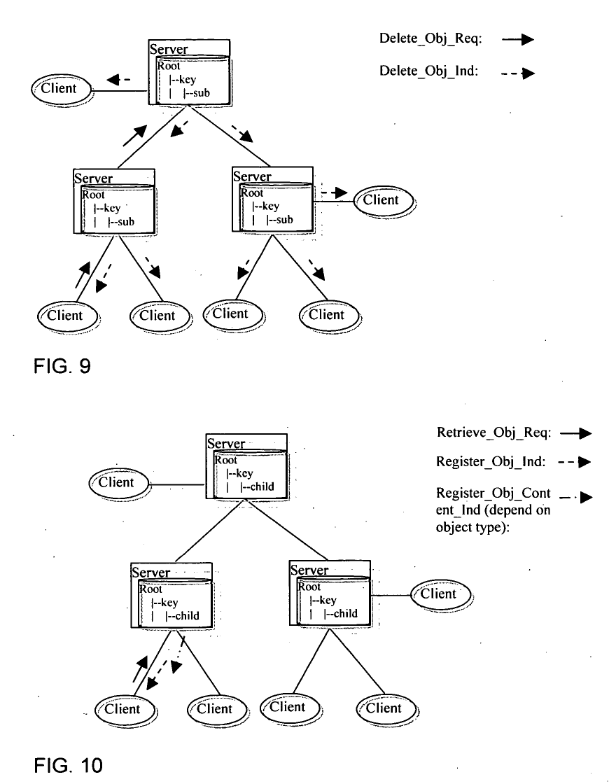

The COMM-DB objects and operations will now be described with reference to FIGS. 8-30. The COMM-DB objects are defined to facilitate the interoperability of commonly required functions such as chat sessions, polling, Q&A sessions, file transfer, whiteboards sharing, document sharing, application sharing and audio/video sessions, or the like, in the distributed server architecture through the generalization of their actual data operation model.

Each COMM-DB object resides as a leaf in the hierarchically structured tree. The object inherits the ownership, modification permission and monitor channel from its parent key. Common COMM-DB object attributes are as follows.

Object Name

Each object has a name consisting of one or more UTF-8 encoded characters to support localized application languages. The name of each object is unique with respect to the parent key that is immediately above it in the hierarchy.

Object name length is limited to 32 bytes.

Object ID

Once an object is registered, a unique 4 byte long unsigned ID is assigned to this object. The lower two bytes serve as an index to quickly locate this object in future object-operations, the higher two bytes contain a two bytes random number for validation. The format of the Object ID is similar to the Key ID described hereinabove.

Objects are stored in an array under its parent key. To locate an object under its parent key by object_id, it only takes one step:
Object=Object_Array[object_id&0xffff].
   Object Type

An Object is categorized by its type. Each object type has its own data structure and operations. The object types can vary depending on the applications being run, and the object types set forth herein are for exemplary purposes only. Those of ordinary skill in the art would recognize that other object types can be defined for other applications. The following object types will be described in detail below and used as examples for illustrating principles of the present invention.
Parameter
Token
Roster
Table
Handle
Counters
Queue
Edit
Cache
   Object Taq

Object tag is a 4 byte long unsigned value set by the application. It is only meaningful to the application.

Object Data Delivery Flag

This flag is an unsigned byte, it defines generally how an object requires the multipoint communication server to delivery its data and command, for example, in which priority and in what model (uniform or non-uniform). The structure of the object data delivery flag is shown in the table below.

| | | | | | | | |
|---|---|---|---|---|---|---|---|
| 0 | 1 | 2 | 3 | 4 | 5 | 6 | 7 |

| | | | | | | |
|---|---|---|---|---|---|---|
| Priority | Uniform | 0 | 0 | 0 | 0 | 0 |

Uniform sequencing is necessary when operation on a same object is requested simultaneously from several client applications, and must be received in the same sequence by all receivers. All the uniformly sequenced requests are routed to the Top COMM-DB 20 and from there dispatched in the same order to all the receiver clients, including the sender if it is a member of the monitor channel. If the sequence of the operation of this object is not important, or the client application can ensure the sequence through other means, the uniform bit here is not necessarily set.

Similar to the commands described above with respect to the COMM-DB keys, common object operations can be performed according to principles of the present invention. The operations include Registering an object, Deleting an object and Retrieving an object. The sequence of messages exchanged during execution of the operations is shown in FIGS. 8-10. As can be seen from the figures, the message exchange sequences are similar to those of the corresponding key commands. The common object operations are described in the following sections.

A new object can be created by a client application issuing a Register-Object-Request command to the top COMM-DB. After receiving this request, the top COMM-DB needs to check if this object already exists or if the requestor has the permission by checking its parent key's modification permission attribute. If this is not a duplicated object and it is allowed, the top COMM-DB will create the new object, assign an object id for it, and insert it into the local tree repository, then confirm the requestor with a SUCCESS Register-Object-Confirm message. Otherwise, top COMM-DB will confirm the requestor with a FAILURE Register-Object-Confirm message. Upon the successful registration, the top COMM-DB will issue a Register-Object-Indication message to all the nodes joined to its monitor channel. After receiving the Register-Object-Indication message, client applications may handle it according to their own application logic and sub COMM-DBs will insert this new object into its local tree repository.

The following table shows the parameters used in register-object events:

| Parameter | Request | Confirm | Indication | Comments |
|---|---|---|---|---|
| Parent Key | x | x | x | Full name, contains full |
| name | | | | path. Started from root |
| | | | | ‘\’. |
| | | | | E.g. |
| | | | | \Startup\Sess_Table” |
| Parent Key ID | ∘ | x | x | |
| Object name | x | x | x | |
| Object ID | — | x | x | |
| Object Type | x | x | x | |
| Object Tag | x | x | x | |
| Object DDF | x | x | x | data delivery flag |
| Result | — | x | — | |

| | |
|---|---|
| Extra data | Depends on specific type of objects |

An object can also be deleted by a client application issuing a Delete-Object-Request command to the top COMM-DB. After receiving this request, the top COMM-DB needs to check if the requestor has the permission by checking its parent key's modification permission attribute. If it is allowed, the top COMM-DB will delete this object from the local tree repository. Upon the successful deletion, the top COMM-DB will issue a Delete-Object-Indication message to all the nodes joined to its monitor channel. After receiving the Delete-Object-Indication message, client applications may handle it according their own application logic, and sub COMM-DBs will delete this object from its local tree repository.

The following table shows the parameters used in delete-object events:

| Parameter | Request | Confirm | Indication | Comments |
|---|---|---|---|---|
| Key name | x | x | x | Full name, contains full |
| | | | | path. Started from root |
| | | | | ‘\’. |
| | | | | E.g. |
| | | | | “\Startup\Sess_Table” |
| Key ID | x | x | x | |
| Object | x | x | x | |
| name | | | | |
| Object ID | x | x | x | |
| Requestor- | x | x | x | |
| Node-ID | | | | |

Additionally, client applications may issue a Retrieve-Object-Request command to its parent COMM-DB to retrieve object information. After receiving this request, the parent COMM-DB needs to return this object's information to the requester.

The following table shows the parameters used in retrieve-object events:

| Parameter | Request | Comments |
|---|---|---|
| Key name | x | Full name, contains full |
| | | path. Started from root ‘\’. |
| | | E.g. “\Startup\Sess_Table” |
| Key ID | ∘ | |
| Object name | x | |
| Object ID | ∘ | |

The object types set forth above will now be described in detail.

Parameter Object

Parameter object is defined for peer client applications to share a dynamic binary value. The major difference between this object with all others is that monitoring client applications will be notified of its value in the register-object-indication, it doesn't need an extra object-content-indication message for the notification.

Extra data used in register-object events:

| | Register- | Register- | Register- | |
|---|---|---|---|---|
| | Object- | Object- | Object- | |
| Parameter | Request | Confirm | Indication | Comments |
| Parameter | x | — | x | An octet string with |
| value | | | | maximum length |
| | | | | 1024 bytes |

Parameter Object Operations

Parameter Update

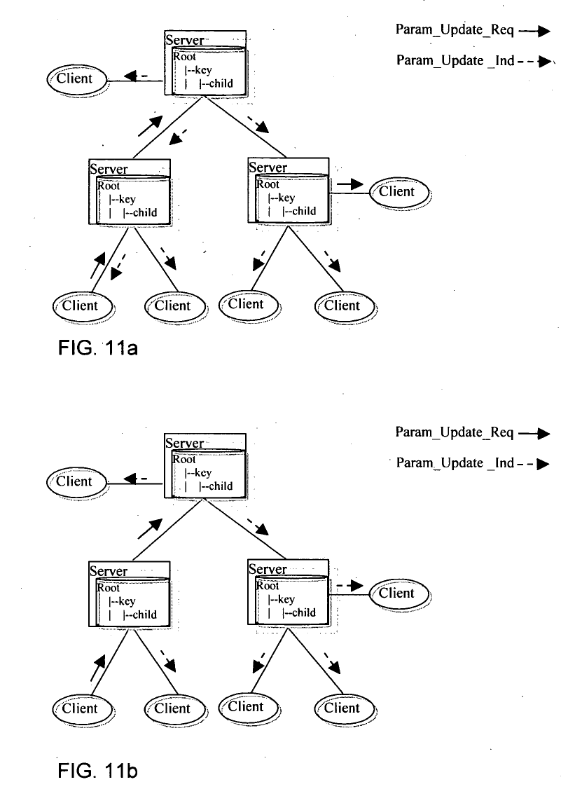

Client applications may update a parameter value by issuing a Parameter-Update-Request command. Both uniform and non-uniform mode are supported. The sequence of events during a parameter update operation in uniform and non-uniform mode is shown in FIGS. 11a and 11b, respectively

When a COMM-DB receives this request, it will check the permission, update the value in the local repository, and redistribute the command to all other members in its monitor channel.

The following table shows the parameters used in parameter-update events:

| Parameter | Request | Confirm | Indication | Comments |
|---|---|---|---|---|
| Parent Key ID | x | | x | |
| Object ID | x | | x | |
| Object Value | x | | x | an octet string with |
| | | | | maximum length |
| | | | | 1024 bytes |

Token Object

A token object is related to the ITU T.120 resource token, which provides a means to implement exclusive access to a given resource. For example, to ensure in a multipoint application using resources that one and only one client application holds a given resource at a given time, a token can be associated with every resource. When a client application wishes to use a specific resource, it must ask for its corresponding token, which will be granted only if no one else is holding it.

The major difference with T.120 token and that according to principles of the present invention, is that a grabber-key concept is introduced. The grabber key is a UTF-8 encoded character string with maximum length of 16 bytes. If it is set non-empty when a token is created, a client must provide the grabber-key when it tries to grab this token. Another operation difference is that when monitor channel is set, the token status and grabber change will be notified to all the members in the monitor channel. Such actions are not recommended in the T.120 protocol.

Token operations do not support non-uniform mode.

Extra data used in register-object events:

| | Register-Object- | Register-Object- | |
|---|---|---|---|
| Parameter | Request | Indication | Comments |
| Initial grabber | ∘ | X | Initial grabber |
| node ID | | | |
| Status | x | X | Initial status |
| Grabber key | X | — | |

The following operations are associated with tokens and are similar to the token operations, with the exceptions noted above, defined in the ITU T.120 protocol.
Token Grab
Token Inhibit
Token Please
Token Give
Token Release
Token Test
   Roster Object

The purpose of a roster object is similar to the T.120 GCC roster, which provides a means for client applications to announce its presence to its peers. However, the T.120 GCC roster can be inefficient when supporting a large number of participants through the Internet. The data structure, the functionalities and how it is propagated are implemented in a different way in accordance with principles of the present invention.

In the present invention, a roster object simply provides a general repository to store a list of records, each record associated with a client-server connection. Each application can decide if it needs its own roster according to its operation model.

Roster records are stored in a two tier tree structure. The root is a server, and leaf is a roster record associated with a local client-server connection.

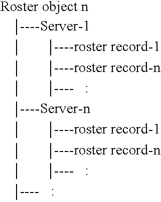

A roster record is composed of:
Node ID: an unsigned short to identify the record,
Presence flag: 16 bits unsigned short, bit 1 is pre-defined by COMM-DB system, used to indicate if the record needs be propagated to its peers, other bits are specified by application;
Presence Status: 32 bits long unsigned, specified by application; and
Presence Data: an octet string with maximum length of 256 bytes, specified by application.

If a client is disconnected, the local COMM-DB will remove the roster record associated with this connection from its repository, and, if the record is a public roster record, COMM-DB needs to propagate its removal to all the members in the monitor channel.

If a sub server is disconnected, the local COMM-DB will remove all the roster records under this server from its repository. Since the server disconnection event will be propagated to all the nodes within the domain, if is not necessary for COMM-DB to propagate this roster remove event to other members.

Roster operations only support none uniform mode.

Extra data used in register-object events

None

Roster Operations

Presence Announce and Update

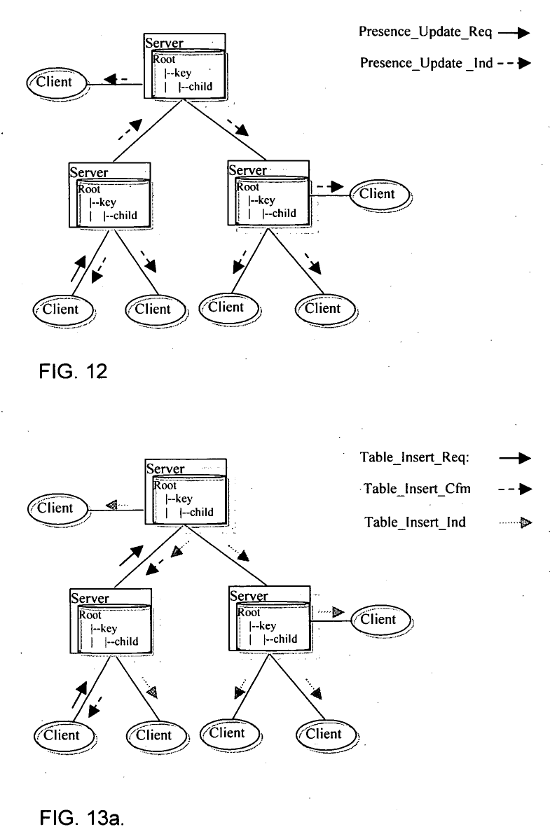

The sequence of events occurring during a Presence Announce and Update roster operation is shown in FIG. 12. As seen in the figure, a client application can announce its presence or update its presence information by issuing a Presence-Update-Request command to its parent COMM-DB. Parent COMM-DB will then store it in the local roster list. If this roster record's public bit in presence flag is set, COMM-DB need propagate this presence announce/update along with the total number of local roster records to all the nodes joined its monitor channels. Other COMM-DB who received this propagation, need store it in its local roster repository. If multiple Presence-Update-Requests are submitted at same time, COMM-DB will propagate them out in a batch to optimize the transportation.

The following table shows the parameters used in presence-update events:

| Parameter | Request | | Comments |
|---|---|---|---|
| Parent Key ID | x | x | |
| Roster Object ID | x | | |
| Client Node ID | x | | |
| Presence Flag | x | | |
| Presence Status | x | | |
| Presence Data | x | | |

| Parameter | Indication | Comments |
|---|---|---|
| Parent Key ID | x | |
| Roster Object ID | x | |
| Total number of local records | x | |
| Number of updated records | x | |
| Update records | x | Roster Update Record: |
| | | Update flag |
| | | Node ID |
| | | Presence flag |
| | | Presence status |
| | | Presence data |

Table Object

A table object simulates a database table. Client applications can use the table object to store a list of records. Each record is identified by a 16-bit unsigned short Record-ID, and consists of an array of fields. Each record field is identified by an 8-bit index and consists of a octet string with maximum length of 65535 bytes.

The structure of a table record consists of:
Record ID: A 16-bit unsigned long, used to index the record in the table. In non-uniform mode, the record ID needs be generated by client application and it is client application's responsibility to ensure it is unique.
Record Tag: A 32-bit unsigned long, specified by client application.
Number of record fields: An 8-bit unsigned byte, it tells the number of record fields it contains.
Record field array: An array of the record fields, each field is a octet string with maximum length 65535 bytes.

Extra data used in register-object events

| | Register-Object- | Register-Object- | |
|---|---|---|---|
| Parameter | Request | Indication | Comments |
| Maximum | x | x | 16-bit unsigned short, |
| number of | | | define the maximum |
| records | | | number of records this |
| | | | table can contain |

Table Operations

Insert Records Operation

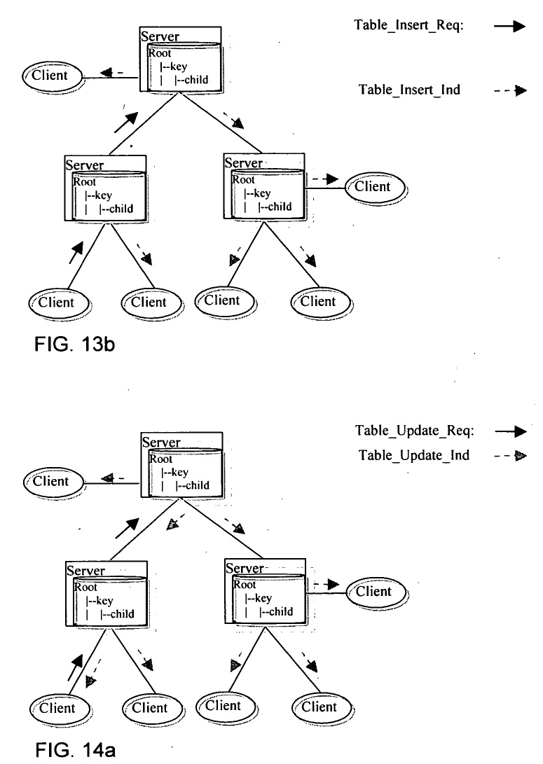

A client application may issue a Table-Insert-Request command to insert records. Multiple records can be inserted at one request. The insert records operation supports both uniform and non-uniform mode. For non-uniform mode, the record id needs be generated by a client application and assured unique and no confirm is needed. For uniform mode, the request will be routed to the top COMM-DB, COMM-DB will generate a unique record id for this record, confirm the result and propagate the insertion to all the members joined its monitor channel. FIGS. 13a and 13b illustrate the sequence of events during a table insert operation in uniform and non-uniform mode, respectively.

The following table shows the parameters used in table-insert events:

| Parameter | Request | Indication | Comments |
|---|---|---|---|
| Parent Key ID | x | x | |
| Table Object | x | x | |
| ID | | | |
| Number of | x | x | |
| records | | | |
| Records | x | x | |
| Array | | | |

Table Update Operation

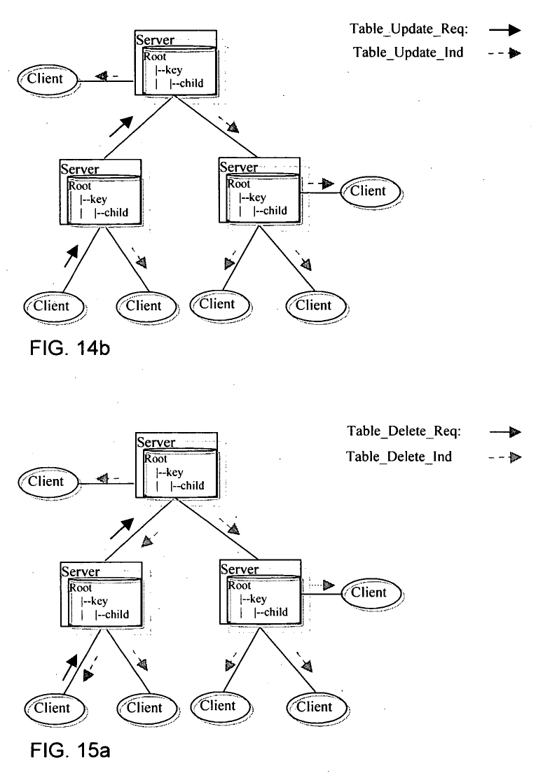

A client application may issue a Table-Update-Request command to update a record. It can update either the whole record or update only partial fields of the record. The table update operation supports both uniform and non-uniform mode, as shown in FIGS. 14a and 14b, respectively.

The following table shows the parameters used in table-u date events:

| Parameter | Request | Indication | Comments |
|---|---|---|---|
| Parent Key ID | x | x | |
| Table Object | x | x | |
| ID | | | |
| Record id | x | x | |
| Number of | x | x | |
| update fields | | | |
| Update fields | x | x | update field: |
| List | | | Index of the field |
| | | | New value of the field |

Delete Record Operation

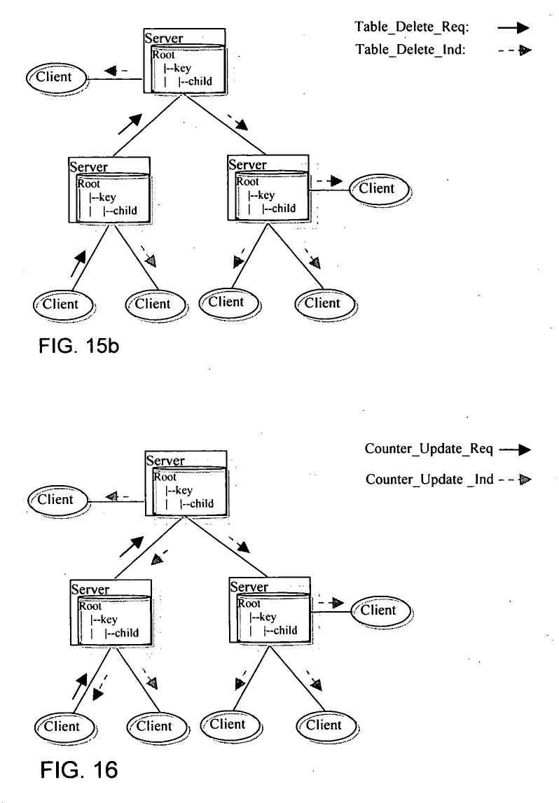

Client applications may issue a Table-Delete-Record-Request to delete a table record. As shown in FIGS. 15a and 15b, both uniform and non-uniform modes are supported.

The following table shows the parameters used in table-delete events:

| Parameter | Request | Indication | Comments |
|---|---|---|---|
| Parent Key ID | x | x | |
| Table Object | x | x | |
| ID | | | |
| Record id | x | x | |

Handle Object

A handle object relates to the ITU T.120 GCC Handle concept. It is used to generate a unique 32-bit Handle for a client application within the scope of a single domain. Extra data used in register-object events: None

The following operations are associated with handles and are similar to the handle operations defined in the ITU T.120 protocol.
Allocate handles
Free handles
   Counter Objects

A counter object provides a group of counters to client applications.

Extra data used in register-object events:

| | Register-Object- | Register-Object- | |
|---|---|---|---|
| Parameter | Request | Indication | Comments |
| Number of counter | x | x | |
| Default value for | x | x | |
| each counter | | | |

Counter Operations

Update Counter

FIG. 16 shows the sequence of events occurring during an update counter operation. Client applications may update a counter by issuing a Counter-Update-Req to Top COMM-DB. When top COMM-DB received this request, it will adjust the counter value accordingly, and then notify the new value of the counters to all the members in its monitor channel.

The following table shows the parameters used in counter-update events:

| Parameter | Request | Confirm | Indication | Comments |
|---|---|---|---|---|
| Parent Key ID | x | | x | |
| Object ID | x | | x | |
| Number of | x | | x | |
| update | | | | |
| counters | | | | |
| updated | x | | x | Each update |
| counter list | | | | counter item |
| | | | | contains: |
| | | | | Counter index |
| | | | | Value |
| | | | | The highest bit of |
| | | | | the index indicates |
| | | | | if this value is a |
| | | | | reset value or delta. |

Queue Object

A Queue object provides client applications with a shared storage to store a list of data items. The difference between a queue object and a table object is that each queue item is identified by its sender node id and send sequence number, and operation of update-queue-item is not supported. Queue objects support both uniform and non-uniform operation modes.

A Queue object consists of:
Sender node id
Sequence number: a 16-bit unsigned short, needs to be unique from the perception of the sender
Item tag: A 32-bit unsigned long, specified by client applications.
Item data: An octet string with maximum length of 65535 bytes.

Extra data used in register-object events

| | Register-Object- | Register-Object- | |
|---|---|---|---|
| Parameter | Request | Indication | Comments |
| Maximum | x | x | 16-bit unsigned short |
| number of | | | |
| items | | | |

Queue Operations

Add Item

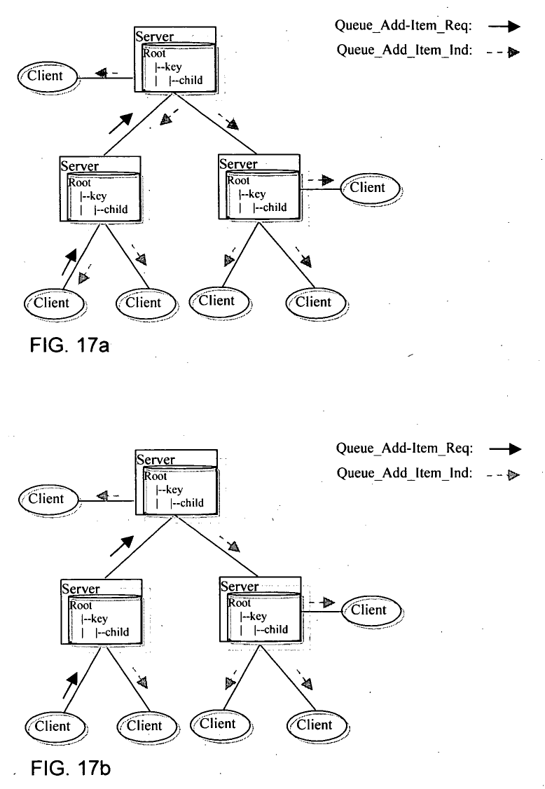

A client application may issue a Queue-Add-Item-Request command to add a new queue item in both uniform and non-uniform mode, as shown in FIGS. 17a and 17b, respectively.

The following table shows the parameters used in queue-add-item events:

| Parameter | Request | Indication | Comments |
|---|---|---|---|
| Parent Key ID | x | x | |
| Queue Object | x | x | |
| ID | | | |
| Number of | x | x | |
| items | | | |
| Item-list | x | x | |

Remove Item

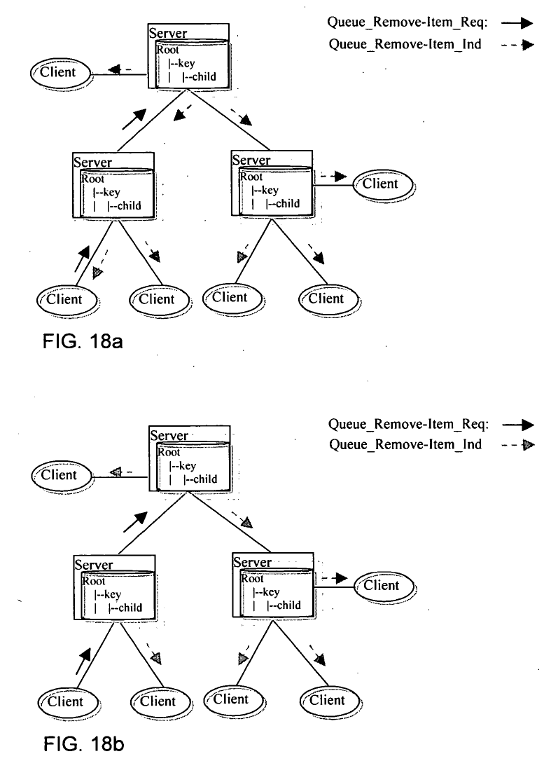

A client application may issue a Queue-Remove-Item-Request command to remove a queue item. FIGS. 18a and 18b, respectively show the sequence of events for a queue remove item operation in uniform and non-uniform modes.

The following table shows the parameters used in queue-remove-item events:

| Parameter | Request | Indication | Comments |
|---|---|---|---|
| Parent Key | x | x | |
| ID | | | |
| Queue Object | x | x | |
| ID | | | |
| Item sender | x | x | If sender node is 0, all the items in |
| node id | | | this queue will be removed |
| Item | x | x | If sequence number is 0, all the |
| sequence | | | items belong to this sender will be |
| number | | | removed |

Edit Object

An Edit object provides a shared edit space for client applications to edit. Client applications only submit the changed portion rather than the whole edit data. Both uniform and non-uniform operation modes are supported by edit objects.

Extra data used in register-object events: None

Edit Operations

Update

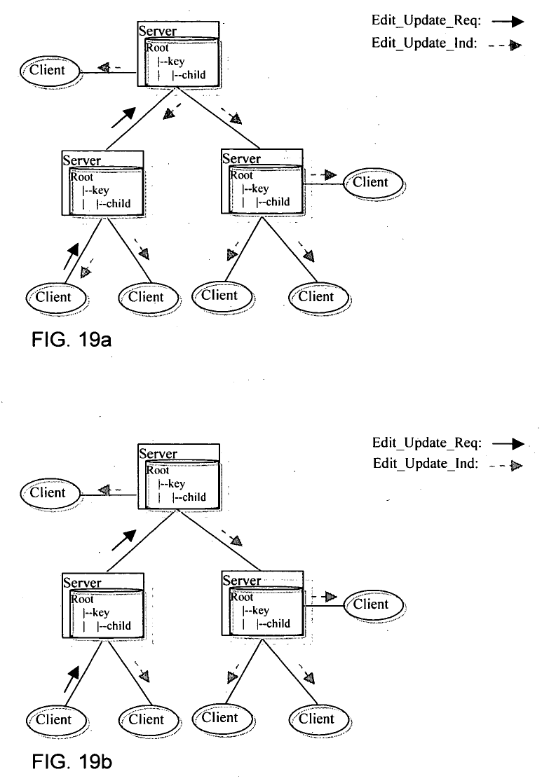

FIGS. 19a and 19b show the sequence of events for an edit-update operation in uniform and non-uniform modes, respectively. A client application issues an Edit-Update-Request command to update the edit data, along with submission of the changed portion. The COMM-DB will replace the specified area of the previous edit data with the submitted changed data.

The following table shows the parameters used in edit-update events:

| Parameter | Request | Indication | Comments |
|---|---|---|---|
| Parent Key ID | x | x | |
| Edit Object ID | x | x | |
| Begin | x | x | |
| position | | | |
| End position | x | x | |
| New data | x | x | An octet string with maximum |
| | | | length 6.4 mega bytes |

Cache Object

A cache object provides an efficient way for client applications to manage, upload and download large cacheable documents, images, files, etc. The cache object can also leverage existing Internet cache infrastructure when the data travels through the Internet.

A cache object consists of a list of cacheable data items. Each cacheable data item is identified by a 16-bit unsigned short index. Cacheable data items are stored in the COMM-DB local file system so that a client application can download it through a standard web server via http get request, thus leveraging the prevalent internet cache infrastructure.

Extra data used in register-object events: None

Operations

Upload and Download Cacheable Data.

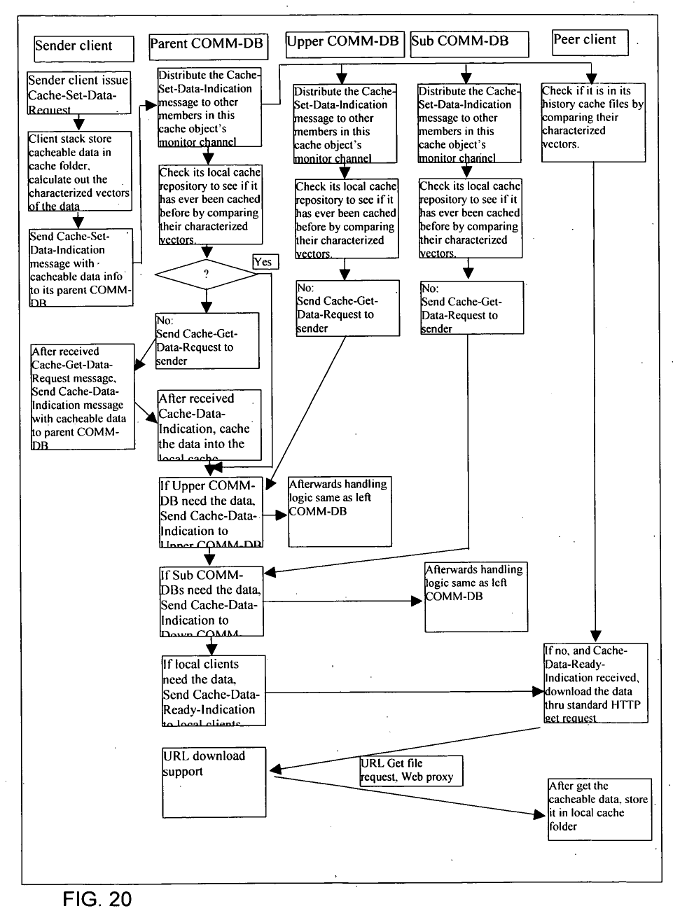

FIG. 20 is a flowchart showing the steps involved for an upload and download cache operation in accordance with principles of the present invention.

The following table shows the parameters used in cache-data-update events:

| | | | Data- | | | |
|---|---|---|---|---|---|---|
| | Set-Data- | Set-Data- | Ready- | Data- | Get-Data- | |
| Parameter | Request | Indication | Indication | Indication | Request | Commends |
| Parent Key | x | x | x | x | x | |
| ID | | | | | | |
| Cache | x | x | x | x | x | |
| Object ID | | | | | | |
| Cache data | x | x | x | x | x | |
| index | | | | | | |
| Cache data | x | x | x | x | x | |
| tag | | | | | | |
| Cache data | — | x | — | — | — | |
| characterized | | | | | | |
| vectors | | | | | | |
| Cache data | x | — | — | x | — | |

Adjust Pending Cache Data Upload and Download Order

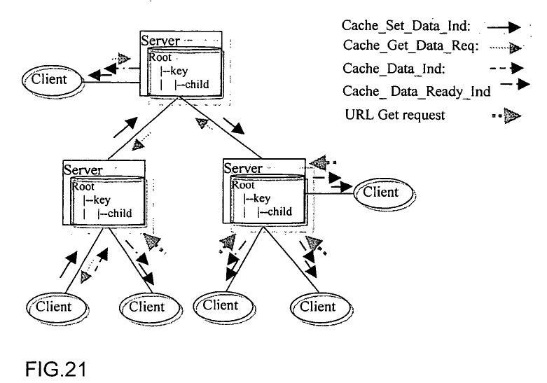

Since client applications may request an upload or download of a large number of large blocks of cache data at same time, it is likely that the upload/download requests will get queued in each local connection buffer. The COMM-DB architecture according to principles of the present invention provides a means for a client application to dynamically adjust the pending upload and download order by issuing a cache-set-data-first command. The sequence of events occurring during the cache-set-data-first operation is shown in FIG. 21.

The COMM-DB architecture and method of the present invention provide several advantages to a distributed multipoint communication system. Because the COMM-DB architecture is a real time distributed database managing resources in a hierarchical tree structure, the COMM-DB closely models the application resource data model. This enables the distributed multipoint communication system to operate efficiently. Additionally, since the COMM-DB is a distributed repository, rather than a central repository, the inventive architecture helps prevent the top server of the multipoint communication system from being overburdened. Further, the present invention provides ways to prioritized the transmission of resource data and provides an efficient and effective way to monitor and synchronize any database changes.

Having thus described various features of the invention, it will now be understood by those skilled in the art that changes in construction and differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

1. A database architecture for effectively delivering conferencing data in a multipoint communication system having a plurality of participating clients, the database architecture comprising a plurality of database nodes for storing and retrieving resource and history status information conferencing data, the plurality of nodes being logically connected in a hierarchical tree structure, wherein the hierarchical tree structure is dynamically formed in accordance with a multipoint domain of the multipoint communication system and wherein each node of the tree structure is associated with a corresponding communication server of the multipoint communication system such that each participating client can obtain resource and history status conferencing data from its closest server.

2. The database architecture of claim 1 wherein the database is a distributed database structure defined within the multipoint communication system.

3. The database architecture of claim 2 wherein the database node residing at a top server of the multipoint communication system becomes a top database node and the remaining database nodes are sub database nodes.

4. The database architecture of claim 2 wherein each database node has a hierarchical tree data structure comprising at least one node called a key, and leaves of the at least one node.

5. The database architecture of claim 4 wherein the leaves of the key can be keys and objects.

6. The database architecture of claim 5 wherein the keys define properties of each participating client and the objects are defined to facilitate interoperability of a variety of conferencing functions.

7. The database architecture of claim 6 wherein each key comprises:
a key name generated by the client;
a key ID generated by the server the client is associated with; and
key attributes.

8. The database architecture of claim 6 wherein the objects are created and used by participating clients to facilitate conferencing functions between clients, wherein the conferencing functions can be a chat session, polling, question and answer session, data transfers, data or application sharing, and audio/video conferencing.

9. The database architecture of claim 8 wherein an object resides as a leaf of a key node and inherits the attributes of its key node and wherein each object comprises:
an object name;
an object ID;
an object type having its own data structure and associated operations;
an object tag having a value meaningful only to the client creating the object; and
an object delivery flag for indicating a priority and mode for performing the object operation.

10. In a distributed multipoint communication system having a hierarchical network topology and a plurality of participating clients communicating with each other over a plurality of logical channels, a method for efficiently distributing conferencing data comprising:
providing a distributed real time communication database defined within the distributed multipoint communication system, the distributed real time communication database comprising a plurality of nodes logically connected in a hierarchical tree structure and the hierarchical tree structure being dynamically formed in accordance with a domain of the multipoint communication system; and
using the distributed real time communication database to store and retrieve conferencing data at the plurality of database nodes, wherein participating clients can obtain the conferencing data from its closest server without overburdening a top server of the multipoint communication system.

11. The method of claim 10 wherein each node of the distributed real time communication database comprises a hierarchically structured tree of keys and objects associated with and used by the participating clients for communicating across the multipoint communication system.

12. The method of claim 11 further comprising performing a key command for modifying or accessing key data in the distributed real time communication database.

13. The method of claim 12 wherein the key command can be: registering a key, deleting a key, retrieving a key and notifying key contents.

14. The method of claim 11 further comprising performing an object operation for modifying or accessing object data in the distributed real time communication database to facilitate conferencing functions between clients, wherein the conferencing functions can be a chat session, polling, question and answer session, data transfers, data or application sharing, and audio/video conferencing.

15. The method of claim 14 wherein the object operation can be: registering an object, deleting an object and retrieving an object.

16. The method of claim 11 wherein there are multiple object types, each object type for facilitating a specified function and wherein each object type has its own data structure and at least one object operation associated with the object type.
